(19) United States
(12) Patent Application Publication
(10) Pub. No.: US 2022/0266365 A1
(43) Pub. Date: Aug. 25, 2022

(54) TOOL COUPLING DEVICE WITH TRANSMISSION UNIT AND METHOD FOR PRODUCING A THREAD OR A THREADED HOLE

(71) Applicant: EMUGE-Werk Richard Glimpel GmbH & Co. KG Fabrik für Präzisionswerkzeuge, Lauf a. d. Pegnitz (DE)

(72) Inventors: Alexander HERTLEIN, Nürnberg (DE); Rainer PORATH, Heroldsberg (DE)

(21) Appl. No.: 17/675,463

(22) Filed: Feb. 18, 2022

(30) Foreign Application Priority Data
Feb. 19, 2021 (DE) 10 2021 103 992.4

(51) Int. Cl. B23G 1/18; B23G 1/46; B23Q 5/04

(52) U.S. Cl. CPC B23G 1/18; B23G 1/46; B23Q 5/048

(57) ABSTRACT

A tool coupling device for coupling a tool can comprise a drive shaft for coupling to the drive, an output shaft for coupling to the tool, the output shaft being rotatable about a central axis (A), a transmission unit connected between the drive shaft and the output shaft and translating a rotational movement of the drive shaft at an input speed (n_{S}) into a rotational movement of the output shaft at an output speed (n_{W}) greater than the input speed (n_{S}) and a non-rotating housing, wherein the transmission unit, and at least a part of the input shaft and a part of the output shaft that are both coupled to the transmission unit, are arranged within the housing, wherein the drive shaft is rotatably mounted on the housing; and wherein the output shaft is rotatably supported solely on the input shaft and is not rotatably supported on the housing.

### CROSS-REFERENCE TO RELATED APPLICATIONS

The present invention claims the benefit of priority to German Patent Application No. 10 2021 103 992.4, filed on Feb. 19, 2021, the entire content which is incorporated herein by reference.

### BACKGROUND OF THE INVENTION

### 1. Field of the Invention

The invention relates to a cable plow system.

### 2. The Relevant Technology

The invention relates to a tool coupling device and a method for producing a thread or a tapped hole.

EP 2 361 712 A2 discloses a method for producing a thread with a thread producing tool on a numerically controlled machine tool and a tool coupling device for coupling the thread producing tool to a machine spindle of the machine tool. In order to increase the working speed of thread forming, the rotational speed of the thread forming tool is translated into high speed with respect to the rotational speed of the tool spindle by means of a transmission gear effectively arranged between the tool spindle and the thread forming tool. This makes it possible to achieve shorter cycle times for thread forming with a given performance of the machine control with regard to its synchronization capability. In this way, the efficiency of the process can also be improved, since nothing can be changed at the synchronization limit of the respective machine tools in use without major effort.

The tool according to EP 2 361 712 A2 is clamped in a collet chuck and the collet chuck is held in a collet chuck holder. The machine spindle is rotatably mounted relative to the housing by needle bearings and is non-rotatably connected inside the housing to an inner ring, on the circumference of which three gear wheels are arranged via bearing pins. On the inside, the three gearwheels mesh with an inner gearwheel, which is non-rotatably coupled to the collet chuck. On the outside, the three gear wheels engage in a gear rim on the inside of an outer ring, which is connected to the housing and thus does not rotate. As planetary gears, the gears and the ring gear form the transmission gear and define the transmission ratio of the gearbox through their teeth. The inner ring is rotatably mounted within the outer ring on its outside via ball bearings arranged circumferentially on the outside of the inner ring and arranged above and below the gears, i.e., on axially opposite sides of the transmission. The collet mount penetrates the inner ring and the transmission gear and ends in an end region shortly after the transmission gear or the inner ring on the drive side, i.e., the side facing away from the collet or tool side. On its inner side, the inner ring is rotatably mounted on the outer side of the end region of the collet chuck receptacle relative to the collet chuck receptacle via circumferential ball bearings provided only on the drive side. The collet chuck receptacle is further rotatably mounted relative to the housing by ball bearings, the ball bearings being arranged circumferentially on the axially front or tool side and the collet chuck receptacle, for example in two rows. Such a coupling device is manufactured and sold by the applicant under the name SPEEDSYNCHRO (see speedsynchro.com). The speed of the machine spindle corresponds to the quotient of the speed of the thread-forming tool and the transmission ratio 4.412, the axial feed corresponds to the product of the thread pitch and transmission ratio 4.412. It includes an axial minimum length compensation, called SOFTSYNCHRO by the applicant, by means of elastomer elements in order to compensate for the axial forces occurring during the threading process, especially at the reversal point.

DE 10 2016 008 478 A1 describes a process for producing a thread in which a single-shot tapping tool is used to drill the core hole and tap the internal thread in a common tool stroke. After a tapping stroke, a groove forming stroke is carried out before the reversing stroke, during which a circumferential groove is formed adjacent to the internal thread without thread pitch, in which the thread profile of the tapping tool can rotate without load. The tapping tool is moved beyond the nominal thread depth for the tapping stroke until a nominal hole depth is reached, at a groove form feed rate and a groove form speed that are not synchronized with each other and are different from the tapping feed rate and the tapping speed. In this way, the tapping speed can be reduced to 0 without causing tool breakage or breakage of the thread profile due to excessive cutting edge load.

A method for producing a thread is known from WO 2019/238175 A1, in which a tool with a thread production part is moved into the workpiece during a working movement comprising a rotary movement and axial feed movement synchronized with the rotary movement according to the thread pitch. In a braking movement following the working movement, the tool is moved further into the workpiece in the same forward direction and with the same direction of rotation as during the working movement up to a reversal point. During the braking movement, the axial feed movement is controlled as a function of the angle of rotation of the rotary movement of the tool in accordance with a previously stored injective relationship, in particular a function or sequence of functions, between the axial feed of the tool and the angle of rotation, the axial feed of the tool being smaller in magnitude than the thread pitch for a full revolution at least during part of the braking movement and being zero at the reversal point. During the braking motion, a circumferential groove or undercut is created in the workpiece. During the deceleration movement in several successive deceleration steps, mutually different relationships, in particular functions, are selected or set between the axial feed of the tool and the angle of rotation, preferably linear functions, wherein the slope of the axial feed decreases in magnitude from one deceleration step to a subsequent deceleration step. This embodiment can be implemented particularly simply by using an NC control for a threading process, for example a G33 path condition, with the thread pitch of the thread for the working movement and also using an NC control, preferably the same one, for a threading process, for example a G33 path condition, with the respective constant pitch as thread pitch parameter in the several braking steps.

After reaching the reversal point, a reversing movement of the tool is initiated according to WO 2019/238175 A1, with which the tool is moved out of the workpiece, comprising a first reversing phase, in which the thread generation part of the tool is guided back into the thread flight of the generated thread, and subsequently a second reversing phase, during which the thread generation part is guided out of the workpiece through the thread flight. The reversing movement in the first reversing phase is controlled with the same amount of pre-stored injective relationship, in particular a function or sequence of functions, between the axial feed of the tool and the angle of rotation, inverted only in the direction of rotation and feed, as in the deceleration movement.

It is also possible, according to WO 2019/238175 A1, to use a combined tool with a drilling section, wherein during the working movement the drilling section of the tool creates a core hole in the workpiece and the threading section creates the thread in the core hole.

### BRIEF SUMMARY OF THE INVENTION

The invention is based on the task of specifying a new tool coupling device for coupling a tool for machining a workpiece, in particular for producing a thread or threaded hole, to a drive. The tool coupling device is preferably intended to achieve a high concentricity, a high rigidity and/or a low dependence on vibrations of the housing.

This task is solved according to the invention in particular by the features of patent claim 1. Advantageous embodiments and further developments according to the invention result in particular from the patent claims dependent on patent claim 1.

The claimable combinations of features and subject matter according to the invention are not limited to the chosen wording and back-relations of the patent claims. In particular, any feature of a claim category, for example a device, can also be claimed in another claim category, for example a method. Further, any feature in the claims, including independently of their back relationships, may be claimed in any combination with one or more other feature(s) in the claims. Further, any feature described or disclosed in the description or drawing may be claimed by itself, independently or apart from the context in which it is found, alone or in any combination with one or more other feature(s) described or disclosed in the patent claims or in the description or drawing.

In one embodiment according to patent claim 1, the tool coupling device comprises a tool suitable and intended for coupling a tool, in particular a tool for producing a thread or a threaded hole, to a drive, in particular a drive of a machine tool,
a) a drive shaft (or: driving shaft, input shaft) for coupling to the drive,
b) an output shaft (or: driven shaft) for coupling to the tool, the output shaft rotating or being rotatable about a central axis,
c) a transmission unit connected between the input shaft and the output shaft and translating, according to a transmission ratio, a rotational movement (or: rotary motion) of the input shaft at an input speed n_{S} into a rotational movement (or: rotary motion) of the output shaft at an output speed n_{W} greater than the input speed n_{S} and
d) a housing that does not rotate,
e) wherein the transmission unit and at least a part of the input shaft coupled to the transmission unit and also a part of the output shaft coupled to the transmission unit are arranged within the housing,
f) wherein the drive shaft is rotatably mounted (or: supported) on or in the housing, and
(g) wherein the output shaft is rotatably mounted (or: supported) solely on or in the input shaft and is, thus, not rotatably (or: torque proof) mounted (or: supported) on or in the housing.

In one embodiment, the output shaft is spaced from the housing. In another embodiment, the output shaft is decoupled from the housing in such a way that housing vibrations are not transmitted directly from the housing to the output shaft.

In an advantageous embodiment, the output shaft has, viewed in the axial direction to the central axis, a holding section for holding the tool or a tool holder for the tool, a front bearing section, a coupling section for coupling to the transmission unit and a rear bearing section, and preferably also an end section, the front bearing section, the coupling section and the rear bearing section being arranged inside the housing and the holding section and, if applicable, also at least partially the end section being arranged outside the housing.

In an advantageous embodiment, the drive shaft has an adapter for coupling to the drive and a carrier section as viewed in the axial direction to the central axis, the carrier section having a rear bearing section (or: rear bearing portion), at least one intermediate section for coupling the transmission unit, and a front bearing section (or: front bearing portion) terminating at an end face, wherein the front bearing section and its end face, each intermediate section, and the rear bearing section are arranged (or: disposed) inside the housing and the adapter is arranged (or: disposed) outside the housing.

In an advantageous embodiment, the output shaft is at least partially arranged within a cavity of the input shaft or at least partially surrounded by the drive shaft. In one embodiment, the output shaft and/or the drive shaft are additionally or alternatively preferably extended along the central axis. In one embodiment, the output shaft and/or the drive shaft are additionally or alternatively at least substantially rotationally symmetrical about the central axis.

In an advantageous embodiment, the output shaft is formed as a one-piece and/or contiguous rigid body of rotation. In an advantageous embodiment, the drive shaft as a whole or at least its carrier section is additionally or alternatively formed as a one-piece and/or contiguous rigid body of rotation.

In an advantageous embodiment, in which the housing has a first opening for, preferably sealed, passage of the output shaft and has a second opening for, preferably sealed, passage of the drive shaft and preferably also of the output shaft, and the central axis runs through the first opening and preferably also the second opening, the first opening is preferably formed in a front housing wall of the housing and the front bearing section preferably extends forward to just close to the front housing wall and faces the front housing wall.

In an advantageous embodiment, an axially continuous central inner channel extends inside the output shaft for supplying coolant and/or lubricant to the tool, for example via a transfer tube in the adapter and via a transfer unit inside the output shaft at both ends of the inner channel.

In an advantageous embodiment, the transmission unit comprises a gear train (or: toothed gear), in particular a planetary gear (train), wherein the gear train comprises a central gear wheel (toothed wheel), an outer gear ring which is fixedly connected to the housing and has an inner toothing, and further comprises one or more intermediate gear wheels (toothed wheels) arranged between the central gear wheel and the inner toothing, which intermediate gear wheels each engage with their external teeth or toothing in the external teeth or toothing of the central gear wheel and in the internal teeth or toothing on the gear ring, the central gearwheel being connected fixedly in terms of rotation to the output shaft on the coupling section thereof and preferably the central axis representing the axis of rotation of the central gear wheel, wherein preferably the axes of rotation of the intermediate gear wheels are parallel to the central axis.

In an advantageous embodiment, each intermediate gear wheel is inserted in a wheel receptacle (or: wheel seat) formed as a cutout in the drive shaft, in particular in the carrier section, wherein in the case of several wheel receptacles in the circumferential direction between two wheel receptacles there is in each case an intermediate section of the carrier section and wherein preferably the axial thickness of the wheel receptacle(s) corresponds substantially to the axial thickness of the gear ring.

In an advantageous embodiment in which each intermediate gear is rotatably mounted (or: supported) on an associated axle pin, each axle pin is preferably inserted at the end face into the front bearing section of the carrier section and extends through a central bearing hole in the respective intermediate gear wheel through the associated wheel receptacle into the rear bearing section of the carrier section.

In a further advantageous embodiment in which the drive shaft is rotatably supported in the housing via front rolling bearings and rear rolling bearings arranged axially with respect to the central axis on opposite sides of the transmission unit, each of which is preferably arranged in close proximity to the transmission unit, in particular the front rolling bearings are arranged on the front bearing section of the carrier section and the rear rolling bearings are arranged on the rear bearing section of the carrier section.

In a further advantageous embodiment according to the above embodiments, or in a further embodiment in which the output shaft is rotatably supported (or: mounted) on or in the input shaft via front rolling bearings and rear rolling bearings, which are arranged axially with respect to the central axis on opposite sides of the transmission unit. The front rolling bearings are preferably arranged between the front bearing section of the carrier section and the front bearing section of the output shaft. The rear rolling bearings are preferably arranged between the rear bearing section of the carrier section and the rear bearing section of the output shaft.

In an advantageous embodiment, the rear rolling bearings between the drive shaft and housing and the rear rolling bearings between the input shaft and output shaft do not overlap in a radial projection on the central axis.

In a further advantageous embodiment, the front rolling bearings between the drive shaft and the output shaft, viewed axially, start in the immediate vicinity of the transmission unit and extend in the axial direction with respect to the central axis over most of the front bearing section of the carrier section and/or up to the vicinity of the end face.

Another advantageous embodiment comprises a rotary fixing unit for absorbing or receiving the torques acting through the transmission unit.

A likewise advantageous embodiment of the invention represents a method for producing a thread or threaded hole in a workpiece, wherein
a) a tool coupled to a drive by a tool coupling device according to any one of the preceding claims is used to produce a thread or threaded hole having a thread producing part (or: portion, section, region),
b) the tool is moved into the workpiece in a working movement during a first working phase, wherein the working movement comprises a rotary movement with a predetermined direction of rotation about the central axis and an axial feed movement of the tool synchronized with the rotary movement in an axial forward direction axially to the central axis according to the thread pitch, such that a full rotation of the tool corresponds to an axial advance of the tool by the predetermined thread pitch, and wherein during the first working phase in the working movement the thread generating part generates a thread turn in the workpiece which is below the predetermined thread pitch,
c) the tool is moved in a braking movement (or: deceleration movement) during a second working phase following the first working phase further into the workpiece up to a reversal point, wherein the axial advance of the tool relative to a full revolution is smaller in amount than the thread pitch at least during a part of the braking movement, preferably during the entire braking movement, and is zero at the reversal point, and wherein the thread-generating part of the tool generates at least one, in particular closed or annular, circumferential groove in the workpiece during the braking movement,
d) the transmission ratio of the transmission unit is maximum 1:3.

In an advantageous embodiment, the transmission ratio is selected between 1:3 and 1:10, in particular between 1:4 and 1:8, preferably between 1:4 and 1:5.

In an advantageous embodiment, the tool further comprises at least one drilling part for generating a core hole. The drilling part is arranged in a region located further forward, in particular at a forward or free end, than the thread-generating part. The drilling part and the thread-generating part are rigidly motion-coupled to each other and/or are mounted or formed on a common tool carrier or tool shank. Preferably, during the working movement, the drilling portion of the tool produces a core hole in the workpiece and the thread producing portion produces a thread in the surface of this core hole extending below the predetermined thread pitch. The thread forming part generally projects radially outward from the tool axis further than the drilling part. As a result, the thread can be produced without radial infeed of the tool and the drill part can be moved out again during reversing without destroying the thread through the core hole.

The tool coupling device according to the invention has proven to be particularly advantageous with regard to rigidity and concentricity properties as well as insensitivity to vibrations of the housing.

In a further embodiment according to the invention, it may be provided that
d) during the working movement, the (actual) rotational speed of the rotary movement of the tool passes through a first plateau in its temporal course, at which the rotational speed remains constant at a predetermined (or: programmed or entered in the control program) maximum rotational speed, and
e) during the braking or deceleration movement, the (actual speed) of the rotary movement of the tool passes through a second plateau in its temporal course, during which the speed remains constant at the same predetermined maximum speed,
f) wherein the predetermined maximum rotational speed of the rotary movement of the tool is selected to be at least so large that a path speed at the thread generation area of at least 57 m/min, in particular of at least 85 m/min, is achieved, which corresponds to a maximum rotational speed of at least 3,000 rpm, in particular at least 4,500 rpm, for a thread diameter of 6 mm.

In another embodiment according to the invention, it is provided that in the programming of the machine drive, a maximum speed of rotation of the machine drive is programmed which corresponds to the product of the transmission ratio and the predetermined maximum speed of rotation on the tool.

In one embodiment, there is between the time interval of the first plateau of the rotational speed and the time interval of the second plateau of the rotational speed is an intermediate time interval in which the rotational speed drops below the maximum rotational speed. In one embodiment, the ratio of the interval length of the intermediate time interval to the interval length of the time interval of the second plateau is in a range from 0.5 to 2.4. In one embodiment, the interval length of the second plateau is selected in a range from 0.01 s to 0.25 s, in particular from 0.02 s to 0.13 s, and/or the interval length of the intermediate time interval is selected in an embodiment between 0.05 s and 0.15 s, in particular between 0.06 and 0.10 s. In one embodiment, the maximum speed is already reached at the beginning of the first working phase or the working movement or at the entry point of the tool into the workpiece. In one embodiment, the maximum path speed reached at the thread generation part is selected in a range from 57 m/min to 189 m/min, in particular from 85 m/min to 132 m/min.

The thread generation part generally has an effective profile that corresponds to the thread profile of the thread to be generated. In one embodiment, the thread generation part has at least one thread tooth, preferably two thread teeth, preferably in a front area of the tool.

The braking movement preferably comprises a rotary movement with the same direction of rotation as in the working movement. As a rule, the braking process or the second working phase starts at an axial feed corresponding to the thread pitch of the first working phase. The braking process is to be understood as braking from the initial thread pitch down to zero at the end or at a reversal point and does not have to involve a reduction in the axial feed as a function of the angle of rotation (braking acceleration), in particular to values below the thread pitch, over the entire rotation angle interval. Rather, it is also possible to have rotation angle intervals in which the axial feed relative to the rotation angle is zero or is even temporarily negative, i.e., reverses its direction. In a preferred embodiment, during the braking motion, the axial feed motion is controlled depending on the angle of rotation of the rotary motion of the tool according to a previously stored bijective relationship, in particular a function or sequence of functions, between the axial feed of the tool and the angle of rotation. A function defining the relationship between axial feed (or: the axial penetration depth) and the angle of rotation may have a continuous definition range and value range, or it may have a discrete definition range and value range with discrete pre-stored or predetermined value pairs or value tables. In one embodiment, the rotational speed of the rotary movement at the reversal point is also zero and/or the total or summed axial feed of the tool during the braking or deceleration movement is selected or set between 0.1 times and 2 times the thread pitch.

In a preferred embodiment, different relationships, in particular functions, between the axial feed of the tool and the angle of rotation are selected or set during the braking movement in several successive braking steps. In a particularly advantageous embodiment, a linear function of the angle of rotation is selected for the axial penetration depth or the axial feed during several, in particular also all, braking steps and/or the (programmed) gradient, i.e., the derivative of the axial penetration depth or the axial feed according to the angle of rotation, is constant in each of these braking steps and decreases in amount from one braking step to a subsequent braking step. This embodiment can be implemented particularly simply by using an NC control for a threading process, for example a G33 path condition, with the thread pitch of the thread for the working movement and also using an NC control, preferably the same one, for a threading process, for example a G33 path condition, with the respective constant pitch as the thread pitch parameter in the multiple deceleration steps.

In one embodiment, after reaching the reversal point, a reversing movement of the tool is initiated, with which the tool is moved out of the workpiece, wherein the reversing movement initially comprises a first reversing phase, with which the thread generation part of the tool is guided back into the thread flight of the thread produced, and subsequently a second reversing phase, during which the thread generation area is guided out of the workpiece through the thread flight. The reversing movement is preferably carried out with a course of movement symmetrical to the working movement and braking movement with reversed direction of rotation and reversed feed.

In an advantageous embodiment, the reversing movement in the first reversing phase is controlled with the injective or bijective relationship, in particular a function or a sequence of functions, between the axial feed of the tool and the angle of rotation, which is quantitatively the same, inverted only in the direction of rotation and feed direction, as in the braking movement during the second working phase, possibly omitting or shortening the equalization step, if present.

### BRIEF DESCRIPTION OF THE DRAWINGS

The invention is explained further below by means of exemplary embodiments. Reference is also made to the drawing, in whose

FIG. 1 an embodiment of a tool coupling unit with a transmission unit for coupling a combined drilling and threading tool with a drive unit in a longitudinal section,

FIG. 2 the embodiment according to FIG. 1 in a cross-section, and

FIG. 3 the embodiment according to FIGS. 1 and 2 in a perspective view

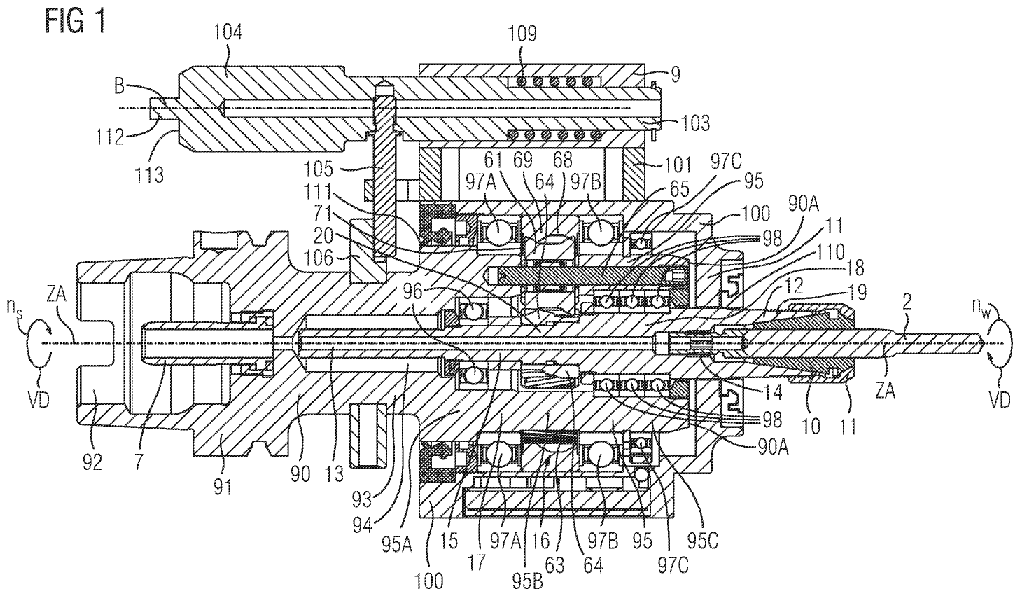

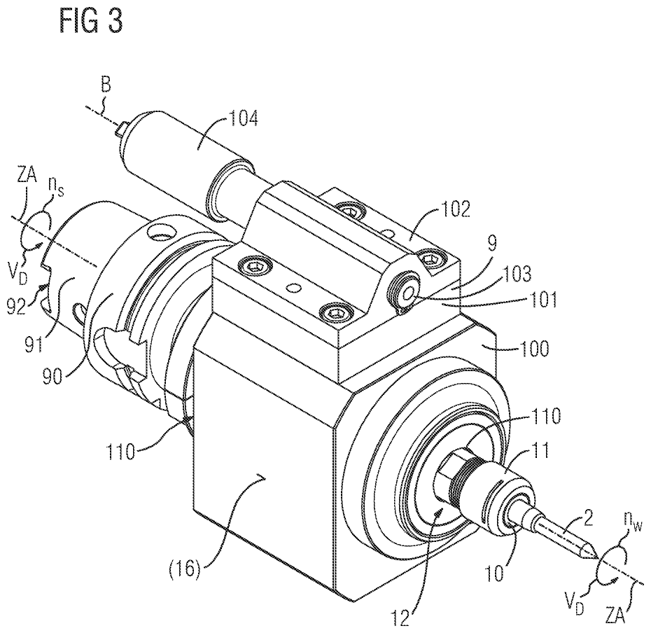

are shown schematically in each case. Corresponding parts and sizes are given the same reference signs in FIGS. 1 to 3.

### DETAILED DESCRIPTION OF THE PREFERRED EMBODIMENTS

In FIGS. 1 to 3 an embodiment of a tool coupling device according to the invention is shown. The tool coupling device is provided for coupling a tool 2 for machining a workpiece, in particular for producing a thread or a threaded hole in the workpiece, to a drive unit (or in short: drive) not shown, in particular to a machine spindle of a machine tool. The tool coupling device comprises an output shaft (or: tool shank, clamping head) 12 rotationally coupled or rotationally couplable to the tool 2, a housing 100, a drive shaft (or: input shaft or machine shank) 90 rotationally coupled or rotationally couplable to the drive unit, and a transmission unit 16 between the drive shaft 90 and the output shaft 12 for translating a rotary motion of the drive shaft 90 into a rotary motion of the output shaft 12 with a constant or variable transmission ratio.

The tool 2 is held in a collet chuck 10, which in turn is held in a clamping section (or: collet chuck receptacle) 19 of the output shaft 12 formed at one end region. To hold the tool 2, the collet 10 is compressed or clamped inwardly by means of a clamping nut 11 screwed onto a thread of the output shaft 12. Instead of a collet 10, another holding means can of course also be provided, for example a quick-change insert or shrink fit chuck.

Following its clamping section 19, the output shaft 12 extends further through an opening 110 of the housing 100 into the housing 100, wherein a front bearing section 18, a coupling section 20 and a rear bearing section 15 and finally an end section 8 of the output shaft 12 are arranged one behind the other, viewed from the opening 110 inward in the axial direction to the central axis ZA. The end section 8 of the output shaft 12 is centrally guided to the outside through a further opening 111 of the housing 100 facing away from the opening 110.

The drive shaft 90 includes an adapter 91 having a receiving space 92 for receiving and coupling a machine spindle or shaft, not shown, of a machine tool or other drive. The adapter 91 can be adapted to various shapes of the machine spindle.

The drive shaft 90 has a hollow shaft 93 adjacent the adapter 90, which encloses a central cavity 94 that receives the output shaft 12, particularly the end portion 8 and the other portions of the output shaft 12 except the tensioning portion 19. The hollow shaft 93 of the drive shaft 90 extends through the further opening 111 of the housing 100 into the housing 100 and extends in a carrier section (or wheel carrier) 95 within the housing 100 up to an end face 90A of the drive shaft 90 or its carrier section 95 shortly in front of the opening 110 of the housing 100. The carrier section 95, viewed axially with respect to the central axis ZA, is subsequently composed of a rear bearing section 95A, a plurality of, in particular three, intermediate sections 95B and at least one front bearing section 95C. The front bearing section 95C forms the end region of the drive shaft 90 and extends forward to just in front of the front housing wall of the housing 100 with the opening 110.

The drive shaft 90 is also preferably formed as a continuous or one-piece body to provide the most rigid design possible without connecting or joining tolerances. However, the drive shaft 90 can also be designed in several parts, for example with an exchangeable adapter 91 for easy adaptation to different machine spindles.

The output shaft 12 and/or the input shaft 90 and/or the collet 10 preferably extended along the central axis ZA and extend along the axis ZA and are preferably formed substantially rotationally symmetrical about the central axis ZA.

Within the output shaft 12, an axially continuous central inner channel 13 extends for supplying coolant and/or lubricant to the tool 2, for example via a transfer tube 7 in the receiving chamber 92 and via a transfer unit 14 within the output shaft 12 at both ends of the inner channel 13.

The output shaft 12 is preferably designed as a contiguous or single-piece body to enable the most rigid design possible without connection tolerances.

The two openings 110 and 111 in the housing 100 are sealed around the drive shaft 12 and output shaft 90, respectively, by seals known in the art.

The output shaft 12 together with the tool 2 held thereon by the collet 10 in co-rotating or torque proof manner and likewise the drive shaft 90 are each rotatable about a central axis ZA in a forward direction of rotation V_{D} (or in a reverse direction of rotation not shown). The drive shaft 90, which is coupled to the machine spindle in a rotationally fixed or torque proof manner, rotates at the input speed (or: machine speed or spindle speed) n_{S} of the machine spindle, and the output shaft 12 together with the tool 2, which is held thereon in a rotationally fixed or torque proof manner via the collet 10, rotates about the central axis ZA in each case at the output speed (or: tool speed) n_{W}.

The transmission unit 16, which is arranged inside the housing 100, is connected between the drive shaft 90 and the output shaft 12. The transmission unit 16 transmits, preferably in the same direction of rotation, the spindle's or drive shaft's input speed n_{S} into the tool's or output speed n_{W} according to the transmission ratio

I=n_{S}/n_{W} of the transmission unit 16. In one embodiment, the transmission ratio I is selected between 1:3 and 1:10, in particular between 1:4 and 1:8, preferably between 1:4 and 1:5.

In the illustrated embodiment, the transmission unit 16 is formed with a toothed gear, in particular a planetary gear (or epicyclic gear). The gear unit or gearbox of the transmission unit 16 comprises a central gear wheel (“sun gear”) 64, an outer gear ring (or: ring gear, annular gear) 69, which is fixedly arranged on the housing 100 or connected to the housing 100, with an internal toothing 68 as well as intermediate gear wheels (or “planetary gears”, planetary gears) arranged between the central gear wheel 64 and the internal toothing 68, for example three intermediate gear wheels 61, 62 and 63. The intermediate gear wheels 61, 62 and 63 each mesh with their external teeth with the external teeth of the central gear wheel 64 and with the internal teeth 68 on the gear ring 69 on the housing 100. The central gear wheel 64 is arranged in an axially central region of the housing 100 and is connected to the output shaft 12 on its coupling section 20 in a rotationally fixed or co-rotating manner. The teeth of the gear wheels 61 to 64 and the internal toothing 68 of the gear set the transmission ratio I of the transmission unit 16.

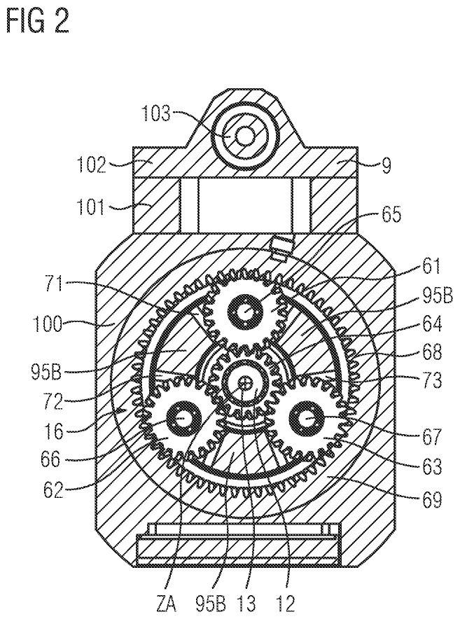

The planetary gear wheels or intermediate gear wheels 61 and 62 and 63 are attached to the carrier section 95 of the drive shaft 90, which is provided as a wheel carrier, preferably as follows. The intermediate gear wheels 61, 62 and 63 are inserted into associated circumferentially spaced cutouts or wheel seats 71, 72 and 73 in the carrier section 95 and are mounted in a torque proof manner by associated axle pins 65, 66 and 67. The wheel receptacles 71, 72 and 73 are located, as can be seen best in FIG. 2, in the circumferential direction between the intermediate sections 95B of the carrier section 95 and in the axial direction with respect to the central axis ZA between the rear bearing section 95A and the front bearing section 95C. The axial thickness of the wheel seats 71 to 73 corresponds essentially to the axial thickness of the gear ring 69.

The axle pins 65, 66 and 67 for rotational mounting of the intermediate gears 61, 62 and 63 are preferably inserted into the carrier section 95 from the front face 90A and extend through a central bearing hole in the respective intermediate gear wheel 61, 62 and 63 through the associated wheel seat 71, 72 and 73 into the rear bearing section 95A and are fixed there, for example by threads. The axes of rotation of the intermediate gear wheels 61, 62 and 63 are defined by the axle pins 65, 66 and 67 and are preferably parallel to the central axis ZA, which is the axis of rotation of the output shaft 12 and the central gear wheel 64 and also preferably of the drive shaft 90. Preferably, the axle pins 65, 66 and 67 are not co-rotating with the corresponding intermediate gear wheels 61 to 63, but rather serve as rotational bearings on and relative to which the associated intermediate gear wheels 61, 62 and 63 rotate. Thus, a small installation space for the gearbox or gear unit can be achieved.

The carrier section 95 of the hollow shaft 93 thus forms the “web” of the planetary gear that rotates with the drive. In the preferred embodiment of the planetary gear shown, the ring gear 69 of the planetary gear is thus non-rotatably or torque proof connected to the housing 100, the web 95 is rotatably connected to the drive shaft 90 and the sun gear 64 is rotatably connected to the output shaft 12. In a first variation of this planetary gear, the planetary gear web may also be rotationally fixed or torque proof to the housing, the ring gear may be rotationally connected to the input shaft, and the sun gear may be rotationally connected to the output shaft 12. In a second variation of this planetary gear, the ring gear may also be rotationally connected to the input shaft, the web of the planetary gear may be rotationally connected to the drive shaft and in a torque-proof or not co-rotating manner to the housing 100, and the sun gear may be rotationally connected to the output shaft 12. Furthermore, instead of such a planetary gear, another gear may be provided for the transmission unit 16, such as a friction gear or other gear.

The transmission unit 16 preferably has an approximately annular basic shape or contour and/or, viewed axially with respect to the central axis, has a largely constant axial thickness which, in the embodiment shown, corresponds to the axial thickness of the transmission ring 69.

The drive shaft 90 is rotatably supported about the central axis ZA via front rolling bearings 97B and rear rolling bearings 97A on both sides of the transmission unit 16 in or on the housing 100 on the inside thereof.

In its rear bearing section 95A, the drive shaft 90 is rotatably supported or mounted on the inside of the housing 100 by means of the rear rolling bearings 97A, which surround the central axis ZA at a constant radius, and in its front bearing section 95C, the drive shaft 90 is rotatably supported or mounted on the inside of the housing 100 by means of the front rolling bearings 97B, which surround the central axis ZA at a constant radius, preferably the same radius as the rear rolling bearings 97A. Axially, the rolling bearings 97A and 97B are disposed in close proximity to or immediately adjacent upstream and downstream of the transmission unit 16. Preferably, the rolling bearings 97A and 97B are each formed with a single row of load bearing large bearing balls. However, multiple rows of bearing balls may be provided, or roller bearings (roller bearings comprise, typically cylindrical or conical, rolls or rollers instead of spherical balls like ball bearings) may be provided.

Further forward, a sensor rolling bearing 97C with smaller bearing balls is arranged, which may comprise a magnet and magnetic sensor for detecting the number of threads produced, as described, for example, in DE 102018121315 A1.

The output shaft 12 is now rotatably mounted exclusively (or: solely) in or on the drive shaft 90 via front rolling bearings 98 and rear rolling bearings 96 on both sides of the transmission unit 16 about the central axis ZA, thus not rotatably mounted on or in the housing 100. This avoids or at least significantly reduces the transmission of vibrations of the housing 100 to the output shaft 12 and thus to the tool 2.

As advantages of this bearing arrangement of the output shaft 12 via the bearings 96 and 98 directly in the drive shaft 90 one can mention, without any limitations, for example:

Improved concentricity, as only one interface is present

No positional deviations of the tool during machining due to housing vibration

Position deviation independent of machining speed (frequency and amplitude level)

Improved Radial Stiffness

The rear rolling bearings 96 are disposed between the rear bearing section 15 of the output shaft 12 and the rear bearing section 95A of the carrier section 95 of the drive shaft 90 and the central axis ZA in circumferential arrangement at constant radius.

The rear rolling bearings 96 between the output shaft 12 and the drive shaft 90 are preferably spaced further from the transmission unit 16 in the direction axial to the central axis ZA than the rear rolling bearings 97A between the input shaft 90 and the housing 100.

Preferably, the rear rolling bearings 97A and the rear rolling bearings 96 do not overlap in an imaginary radial projection onto the central axis ZA, i.e., they are axially offset as seen in the axial direction towards the central axis ZA. In particular, the rear rolling bearings 97A are axially located between the rear rolling bearings 96 and the transmission unit 16. As a result, preferably, the radially acting forces are better distributed axially and the vibrations of the transmission can be prevented by the one-piece and solid design of the drive shaft 90.

Preferably, the rear rolling bearings 96 have a single row of bearing balls, which are in particular smaller than the bearing balls of the rolling bearings 97A, but they may also have several rows of bearing balls. However, roller bearings are also possible.

The front rolling bearings 98 are arranged between the front bearing section 18 of the output shaft 12 and the front bearing section 95C of the carrier section 95 of the input shaft 90 and surround the central axis ZA at a constant radius, although this radius can also be slightly larger than the radius of the rear rolling bearings 96 so that the bearing can be easily mounted. The bearings 98 are preferably selected as large as possible within the construction dimensions in order to achieve a high axial and radial rigidity.

The front rolling bearings 98 for rotational mounting of the output shaft 12 in the drive shaft 90 are arranged axially in the immediate vicinity in front of the transmission unit 16 and extend in the axial direction to the central axis ZA over the major part, in particular at least 60 to 80%, of the front bearing section 95C of the carrier section 95 of the drive shaft 90 up to the vicinity of the end face 90A. Thus, a rigid and stable rotational bearing of the front bearing sections 18 and 95C against each other is achieved.

Preferably, the front rolling bearings 98 comprise several, in particular as shown three, rows of bearing balls arranged axially one behind the other, which are in particular smaller than the bearing balls of the rear rolling bearings 97A. The individual rows of bearing balls can be alternately transmitted in compression and tension and/or braced against each other as a package. Preferably, the front rolling bearings 98 are also (partially) thrust bearings to accommodate the axial forces of the preferred process.

However, the front rolling bearings 98 can also have only one or two rows of bearing balls. In this case, the other rolling bearings 96 would then preferably be designed as thrust bearings. Roller bearings are again possible as bearings 98, preferably tapered roller bearings, in order to absorb axial forces.

The front rolling bearings 97B between front bearing section 95C of the carrier section 95 of the input shaft 90 and the housing 100, on the one hand, and the front rolling bearings 98 between front bearing section 95C of the carrier section 95 of the drive shaft 90 and front bearing section 18 of the output shaft 12, on the other hand, preferably partially overlap in an imaginary radial projection on the central axis ZA to allow a compact structure.

Preferably, viewed rearwardly from the opening 110 of the housing 100, the output shaft 12 has an outer diameter throughout its axial length from the front bearing portion 18 to the end portion 8 that is smaller than the respective inner diameter of the hollow shaft 93 of the input shaft 90, the rolling bearings 96 and 98 being disposed between the outer surface of the output shaft 12 and the inner surface of the hollow shaft 93 of the drive shaft 90. The output shaft 12 is, in other words, radially disposed within or surrounded by the drive shaft 90.

The described bearing arrangement of the drive shaft 90 and the output shaft 12 results in a very rigid and stable structure with excellent concentricity properties. Whereas in the previous S7 chuck mentioned at the beginning there are several interfaces or reference planes, with the present modification according to the invention a higher system rigidity and thus with regard to tolerances and concentricity a higher accuracy is achieved, which is particularly advantageous for the generation and positioning of bores, core holes and tapped holes. The clamping head or the output shaft 12 is supported as a preferably continuous body of rotation projecting on both sides from the housing 100 in the drive shaft 90 (or: shaft), which is preferably also a continuous body of rotation and still ends in the housing, but is no longer supported in the housing 100. As a result, there is only one interface or reference plane and housing vibrations have hardly any influence on the clamping head 12 and the tool 2. The axle pins for the rotary mounting of the planet wheels of the planetary gear of the transmission unit 16 are inserted and fastened from the end face 90A of the drive shaft 90.

In order to absorb the torques generated by the transmission of the transmission unit 16 due to action=reaction, the torque fixing unit 9 shown in FIGS. 1 to 3 above and fixedly connected to the housing 100 is provided as a torque fixing device. In an axial arrangement along an axis B parallel to the central axis ZA, the rotary fixing unit 9 comprises a fixing bolt 103, which is guided in a guide part, and a connecting part 104 for connection to a fixed non-rotating reference system, for example a machine frame or machine housing. In the illustrated non-connected state, the connecting part 104 is free and pressed forward along the axis B by a spring 109 which is supported on the guide part 118 connected to the housing 100. Thereby, a locking element 105 engages in a locking receptacle (locking groove) in an outer ring 106 on the outside of the hollow shaft 93 on the drive shaft 90. A projection 112 and a stop surface 113 serve to provide the connection. On the other hand, in the connected condition not shown, the connecting member 104 is urged rearwardly along the axis B against the spring 109 and the locking element 105 is moved out of the locking receptacle in the outer member 106, thereby rendering the unit operable.

The embodiments of the tool coupling device according to the invention are preferably provided for a thread generating tool or threaded hole generating tool and a method for generating a thread or a threaded hole, which is referred to by the applicant under the designation TAPTOR or is known in particular from WO 2019/238175 A1 mentioned at the beginning, or also for the method described in the general part, but can also be used independently thereof for another rotating tool or method, for example for exclusive drilling.

In contrast to the chuck known from EP 2 361 712 A1 mentioned at the beginning or the applicant's SPEEDSYNCHRO chuck described at the beginning, no minimum length compensation is usually implemented by means of elastomers to achieve a completely rigid coupling.

### LIST OF REFERENCE SIGNS

2 Tool
7 Transfer tube
8 End section
9 Rotation fixing unit
10 Collet
11 Tensioning nut
12 Output shaft (expansion chuck)
13 Inner channel
14 Delivery unit
15 Rear bearing section
16 Transmission unit
18 Anterior bearing section
19 Clamping section
20 Coupling section
61, 62, 63 Intermediate gear wheel
64 Central gear wheel
65, 66, 67 Axle pin
68 Internal gear
69 Gear ring
71, 72, 73 Wheel mounting
90 Drive shaft
90A Front
91 Adapter
92 Recording room
93 Hollow shaft
94 Cavity
95 Girder section
95A Rear bearing section
95B Intermediate section
95C Front bearing section
96 Rear rolling bearings
97A Rear rolling bearings
97B Front rolling bearings
97C Sensor rolling bearing
98 Front rolling bearings
100 Housing
101 Side case
102 Hood
103 Fixing bolt
104 Connection part
105 Locking element
106 External element
109 Spring
110 First opening
111 Second opening
112 Lead
113 Attachment surface
B Axle
n_{S} Spindle speed (drive speed)
n_{W} Tool speed (output speed)
V_{D} Forward direction of rotation
ZA Central axis

1-19. (canceled)

20. A tool coupling device for coupling a tool, in particular a tool for producing a thread or a threaded hole, to a drive, in particular a drive of a machine tool, comprising:
a) a drive shaft for coupling to a drive;
b) an output shaft for coupling to the tool, the output shaft rotating or being rotatable about a central axis (A);
c) a transmission unit connected between the input shaft and the output shaft and translating, in accordance with a transmission ratio, a rotational movement of the input shaft at an input speed (n_{S}) into a rotational movement of the output shaft at an output speed (n_{W}) greater than the input speed (n_{W}); and
d) a non-rotating housing;
e) wherein the transmission unit and at least a part of the input shaft coupled to the transmission unit and a part of the output shaft coupled to the transmission unit are arranged within the housing;
f) wherein the drive shaft is rotatably mounted on or in the housing; and
g) wherein the output shaft is rotatably mounted solely on or in the drive shaft and is not rotatably or torque-proof mounted on or in the housing.

21. The tool coupling device of claim 20, wherein the output shaft is:
spaced from the housing; and/or
decoupled from the housing such that housing vibrations are not transmitted directly from the housing into the output shaft.

22. The tool coupling device according to claim 20, wherein:
the output shaft, seen in axial direction to the central axis (ZA), comprises a holding section for holding the tool or a tool holder for the tool; a front bearing section; a coupling section for coupling to the transmission unit; and a rear bearing section, and preferably also an end section;
the front bearing section, the coupling section and the rear bearing section are arranged inside the housing;
the holding section and possibly also at least partially the end section are arranged inside the housing; and
at least partially the end section is or are arranged outside the housing.

23. The tool coupling device according to claim 20; wherein:
the drive shaft has an adapter for coupling to the drive as viewed in the axial direction toward the central axis (ZA) and a support portion;
the support section has a rear bearing section, at least one intermediate section for coupling the transmission unit and a front bearing section, terminating at an end face; and
the front bearing section and its end face, each intermediate section and the rear bearing section are arranged inside the housing, and the adapter is arranged outside the housing.

24. The tool coupling device according to claim 20, wherein:
the output shaft is arranged at least partially within a cavity of the drive shaft or is at least partially surrounded by the drive shaft; and/or
the output shaft and/or the drive shaft is or is extended along the central axis (ZA) and/or is or is at least largely rotationally symmetrical about the central axis (ZA).

25. The tool coupling device according to claim 20, wherein:
the output shaft is formed as a one-piece and/or contiguous rigid body of rotation; and/or
the drive shaft as a whole or at least its carrier section is formed as a one-piece and/or contiguous rigid body of rotation.

26. The tool coupling device according to claim 20, wherein:
the housing has a first opening for, preferably sealed, passage of the output shaft and has a second opening for, preferably sealed, passage of the drive shaft and preferably also of the output shaft, and the central axis (ZA) extends through the first opening and preferably also the second opening;
the first opening is preferably formed in a front housing wall of the housing; and
preferably the front bearing section extends forwardly to just close to the front housing wall and faces the front housing wall with the front side.

27. The tool coupling device according to claim 20, wherein an axially continuous central inner channel for supplying coolant and/or lubricant to the tool extends within the output shaft, for example via a transfer tube in the adapter and via a transfer unit within the output shaft at both ends of the inner channel.

28. The tool coupling device according to claim 20, wherein:
the transmission unit comprises a gear train, in particular a planetary gear train, the gear train comprising a central gear wheel, an outer gear ring which is fixedly connected to the housing and has an inner toothing, and one or more intermediate gear wheels arranged between the central gear wheel and the inner toothing, which in each case engage with their external toothing in the external toothing of the inner gear wheel and in the internal toothing on the gear ring, the central gear wheel being connected in a rotationally fixed manner to the output shaft on its coupling section and preferably the central axis (ZA) representing the axis of rotation of the central gear wheel; and
preferably the axes of rotation of the intermediate gear wheels are parallel to the central axis (ZA).

29. The tool coupling device according to claim 28, wherein:
each intermediate gear is inserted into a wheel receptacle formed as a cutout in the drive shaft, in particular in the carrier section;
in the case of several wheel receptacles, an intermediate section of the carrier section is located in each case between two wheel receptacles in the circumferential direction; and
preferably the axial thickness of the wheel receptacle(s) corresponds essentially to the axial thickness of the gear ring.

30. The tool coupling device according to claim 28, wherein:
each intermediate gear wheel is rotatably supported on an associated axle pin; and
each axle pin is preferably inserted at the front side into the front bearing section of the carrier section and extends through a central bearing hole in the respective intermediate gear wheel through the associated wheel receptacle into the rear bearing section of the carrier section.

31. The tool coupling device according to claim 20, wherein:
the drive shaft is rotatably supported in the housing via front bearings, preferably rolling bearings, and rear bearings, preferably rolling bearings, arranged axially to the central axis (ZA) on opposite sides of the transmission unit;
the front bearings, and rear bearings, preferably rolling bearings, are each preferably arranged in the immediate vicinity of the transmission unit; and
in particular the front bearings are arranged at the front bearing section of the carrier section and the rear bearings are arranged at the rear bearing section of the carrier section.

32. The tool coupling device according to claim 20, wherein:
the output shaft is rotatably supported on or in the drive shaft via front bearings, preferably rolling bearings, and rear bearings, preferably rolling bearings, the bearings being arranged axially with respect to the central axis (ZA) on opposite sides of the transmission unit;
in particular the front bearings are arranged between the front bearing section of the carrier section and the front bearing section of the output shaft;
wherein:
in particular the rear bearings are arranged between the rear bearing section of the carrier section and the rear bearing section of the output shaft; and/or
in particular the front bearings and/or the rear bearings are formed as axial bearings, in order to absorb axial forces, in particular axial forces coming from the tool or the output shaft.

33. The tool coupling device of claim 31, wherein the rear bearings between the input shaft and the housing and the rear bearings between the input shaft and the output shaft do not overlap in a radial projection onto the central axis (ZA).

34. The tool coupling device according to claim 31, wherein the front bearings between drive shaft and output shaft start in close proximity to the transmission unit, as seen axially, and extend in axial direction to the central axis (ZA) over the major part of the front bearing section of the carrier section and/or up to the vicinity of the front face.

35. The tool coupling device according to claim 20, having a rotary fixing unit for absorbing the torques acting through the transmission unit.

36. A method for producing a thread or threaded hole in a workpiece, wherein:
a) a tool coupled to a drive by a tool coupling device is used to produce a thread or threaded hole having a thread producing part;
the tool comprising:
a drive shaft for coupling to the drive;
an output shaft for coupling to the tool, the output shaft rotating or being rotatable about a central axis (A);
a transmission unit connected between the input shaft and the output shaft and translating, in accordance with a transmission ratio, a rotational movement of the input shaft at an input speed (n_{S}) into a rotational movement of the output shaft at an output speed (n_{W}) greater than the input speed (n_{S}), and
a non-rotating housing;
wherein the transmission unit and at least a part of the input shaft coupled to the transmission unit and a part of the output shaft coupled to the transmission unit are arranged within the housing;
wherein the drive shaft is rotatably mounted on or in the housing; and
wherein the output shaft is rotatably mounted solely on or in the drive shaft and is not rotatably or torque-proof mounted on or in the housing;
b) the method comprises the steps of:
b1) moving the tool in a working movement during a first working phase into the workpiece, wherein the working movement comprises a rotary movement with a predetermined direction of rotation (V_{D}) about the central axis (ZA) and an axial feed movement of the tool synchronized with the rotary movement in an axial forward direction axially to the central axis (ZA) according to the thread pitch, in such a way that a full rotation of the tool corresponds to an axial advance of the tool by the predetermined thread pitch, and wherein during the first working phase in the working movement the thread generating part generates a thread in the workpiece running under the predetermined thread pitch;
b2) moving the tool in a braking movement during a second working phase following the first working phase further into the workpiece up to a reversal point, wherein the axial advance of the tool relative to a full revolution is smaller in amount than the thread pitch at least during a part of the braking movement, preferably during the entire braking movement, and is zero at the reversal point, and wherein the thread-generating region of the tool generates at least one, in particular closed or annular, circumferential groove in the workpiece during the braking movement;
c) wherein the transmission ratio of the transmission unit is a maximum of 1:3.

37. The method according to claim 36, wherein the transmission ratio is selected between 1:3 and 1:10, in particular between 1:4 and 1:8, preferably between 1:4 and 1:5.

38. The method of claim 36, wherein:
the tool further comprises at least one drilling part, and
during the working movement in the first working phase, the drilling portion of the tool produces a core hole in the workpiece and the thread producing portion produces the thread in the inner wall of the core hole produced by the drilling portion.
